(19) United States
(12) Patent Application Publication
(10) Pub. No.: US 2007/0064156 A1
(43) Pub. Date: Mar. 22, 2007

(54) System and method for removing co-channel interference

(75) Inventors: Ming-Luen Liou, Zhonghe City (TW); Chiao-Chih Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/230,065

(22) Filed: Sep. 19, 2005

(51) Int. Cl. H04B 1/10; H04N 5/00

(52) U.S. Cl. 348/614; 348/607; 375/350

(57) ABSTRACT

Methods and system removing co-channel interference from a digital signal. In this method, the digital signal interfered by an interference signal is received, wherein the interference signal comprises consecutive sections, each of which contains N symbols. An average signal is generated by calculating an average over the received digital signal at periodic time instants (n−k*N), wherein N is a constant, n denotes the present time instant and k is a non-negative integer. A first estimated interference signal is generated by filtering the average signal, and the first estimated interference signal is subtracted from the received digital signal and output a first signal.

### BACKGROUND

The invention relates to television signal transmission systems and methods, and more particularly, to methods and systems for eliminating the interfering effects of NTSC analog television signal on digital advance television (DATV) signals when both are simultaneously transmitted in the same frequency band.

Recent years have witnessed the establishment of a standard for transmission of high definition television (HDTV) signals, over both cable and terrestrial broadcast modes. Although it offers significantly enhanced picture resolution, terrestrial broadcast of HDTV signals is somewhat problematic due to the almost universally installed base of conventional NTSC broadcast and more particularly, reception equipment. The present system provides for simultaneous transmission (simultaneous broadcast) of HDTV signals and conventional NTSC analog television signals to provide high definition television services without rendering the installed base of NTSC receivers obsolete. Conceptually, program material is encoded into the two different formats (NTSC and HDTV) and simultaneously broadcast over respectively 6 MHz transmission channels. Viewers having conventional NTSC equipment can receive and view NTSC programming by tuning in the appropriate NTSC channel, while viewers equipped with HDTV equipment can receive HDTV programs by tuning their receiver to the appropriate HDTV channel. While conceptually simple, simultaneous broadcast of NTSC and HDTV signals often results in characteristic portions of an NTSC signal interfering with adjacent channel or co-channel HDTV signals causing degradation of the HDTV signal.

The cause of this form of signal degradation is well understood by those familiar with high definition television transmission systems and is conventionally termed NTSC co-channel interference. Various means have been proposed in the art to reduce NTSC co-channel interference in current HDTV transmission methodologies, and particularly with respect to vestigial sideband (VSB) HDTV transmissions, which form the basis of the HDTV standard in the United States. Certain of these conventional NTSC interference rejection means are summarized in ATSC standard A/53 (1995) ATSC Digital Television standard. Briefly, the interference rejection properties of a conventional HDTV system are based on the frequency location of the principal components of the NTSC co-channel interference within the 6 MHz television channel.

FIG. 1 depicts a typical 6 MHz DTV channel spectrum, represented in baseband in the frequency domain (i.e., symmetric about DC). NTSC co-channel interference is generally recognized as being caused by the three principal carrier components of an NTSC signal; the video carrier, color carrier, and the audio carrier. In the illustrative channel spectrum diagram of FIG. 1, the location and approximate magnitudes of the three principal NTSC components are depicted with the video carrier, indicated at V, located approximately 1.25 MHz from the lower channel band edge. The color carrier, indicated at C, located approximately 3.58 MHz from above the video carrier frequency, and the audio carrier A is located approximately 4.25 MHz above the video carrier frequency. As depicted in the Figure, and is as well understood in the art, NTSC carrier component interference is of particular concern due to the relatively large amplitudes of the video carrier V and color subcarrier C which characterize NTSC transmission. Although the audio carrier A is presented at a relatively smaller amplitude, it nevertheless contributes a significant interference characteristic. Thus, it will be understood that NTSC co-channel interference rejection is an important consideration in the design of HDTV channels to ensure the enhanced quality of an HDTV signal.

### SUMMARY

Embodiments of a method for removing co-channel interference from a digital signal, the digital signal is received and is interfered by an interference signal comprising consecutive sections, each of which contains N symbols. An average signal is generated by calculating an average over the received digital signal at periodic time instants (n−k*N), wherein N is a constant, n denotes the present time instant and K is a non-negative integer. The average signal is filtered to generate a first estimated interference signal, and the first estimated interference signal is subtracted from the received digital signal and outputs a first signal.

Also disclosed are embodiments of a filtering system for removing co-channel interference from a digital signal, wherein the digital signal is interfered by an interference signal comprising consecutive sections, each of which contains N symbols. In the filtering system, an averaging unit generates an average signal by calculating an average over the received digital signal at periodic time instants (n−k*N), wherein N is a constant, n denotes the present time instant and k is a non-negative integer. A first synthesis filter filters the average signal to generate a first estimated interference signal, and a subtracting unit subtracts the first estimated interference signal from the digital signal and outputs a first signal.

Also disclosed are embodiments of a television receiver removing co-channel interference from a digital signal. In the television receiver, a filtering system receives the digital signal and outputs a first signal, wherein the digital signal is interfered by an interference signal comprising consecutive sections, each of which contains N symbols. The filtering system comprises an averaging unit generating an average signal by calculating an average over the received digital signal at periodic time instants (n−k*N), wherein N is a constant, n denotes the present time instant and k is a non-negative integer, a first synthesis filter filtering the average signal to generate a first estimated interference signal based on the average signal, and a subtracting unit subtracting the first estimated interference signal from the digital signal and outputting the first signal.

### DESCRIPTION OF THE DRAWINGS

The invention can be more fully understood by the subsequent detailed description and examples with reference made to the accompanying drawings, wherein:

FIG. 1 depicts a typical 6 MHz DTV channel spectrum;

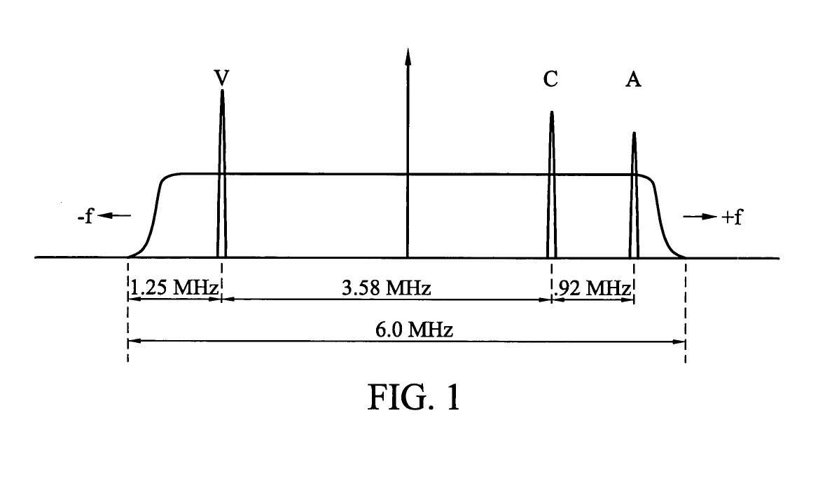

FIG. 2A shows a first embodiment of a digital television receiver;

FIG. 2B shows a second embodiment of a digital television receiver;

FIG. 3 is a diagram of NTSC interference signal received by the digital television receiver; and

FIG. 4 is a flowchart showing an embodiment of a method for removing a co-channel NTSC interference from a digital television signal.

### DETAILED DESCRIPTION

### First Embodiment

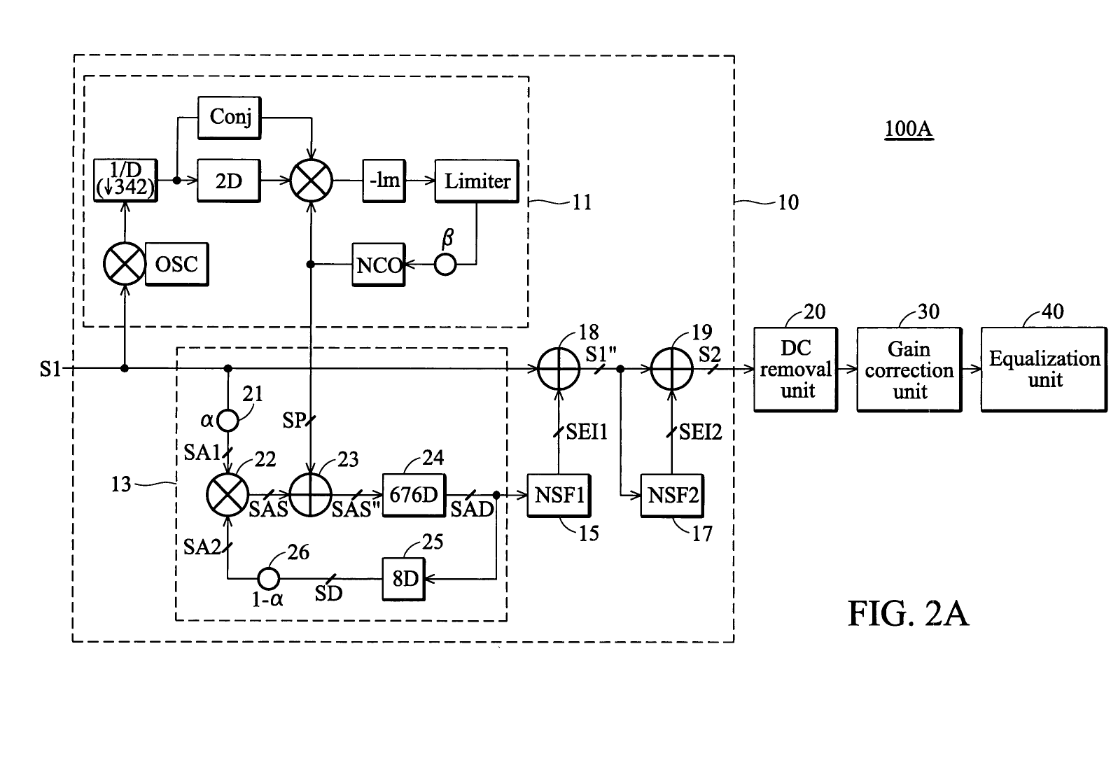

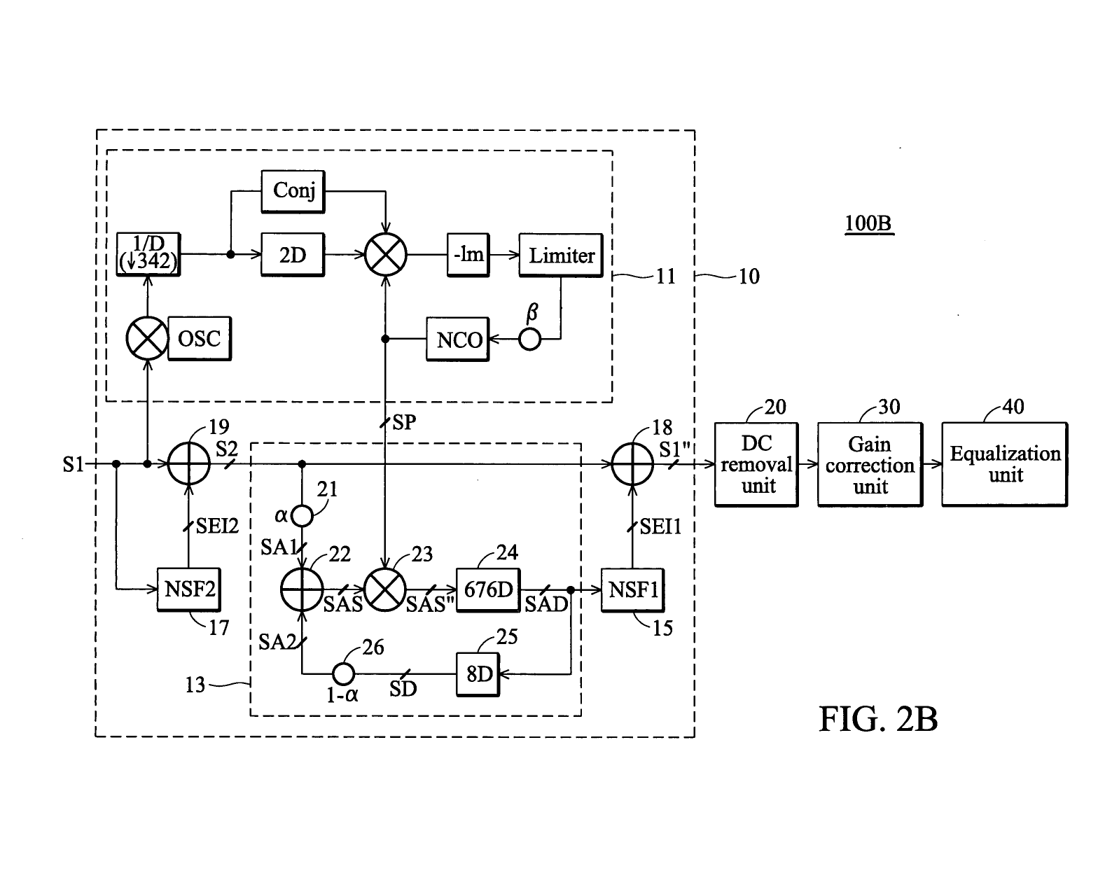

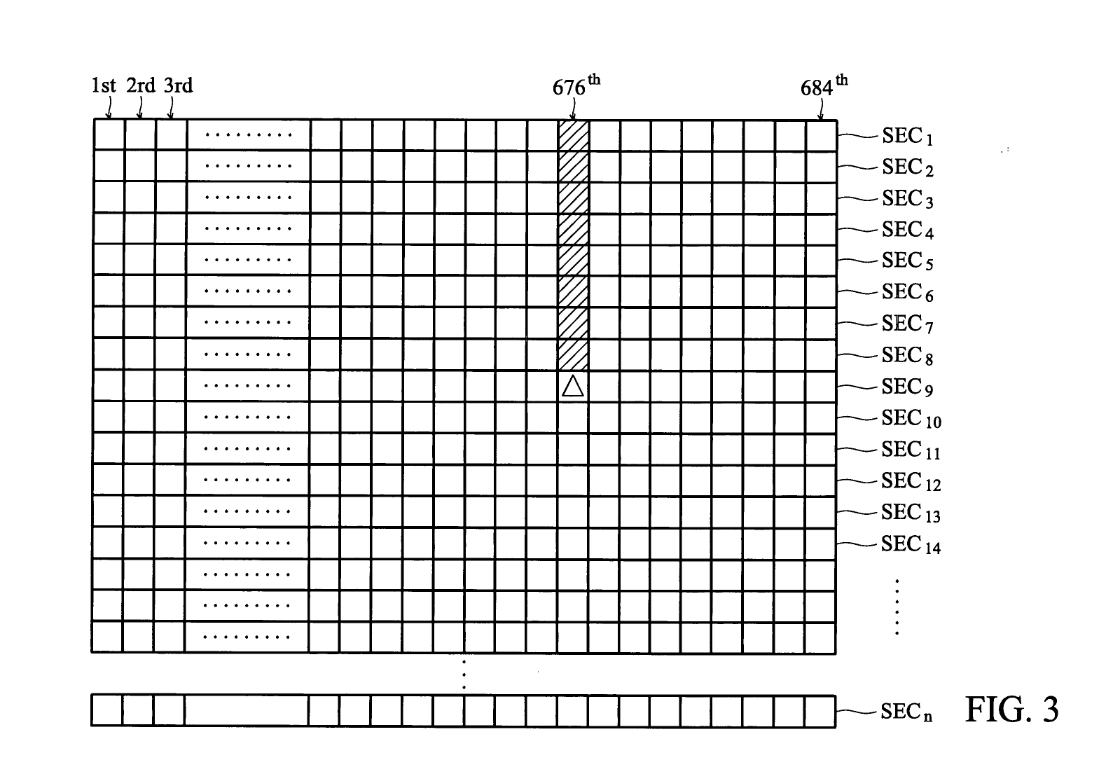

FIG. 2A shows a first embodiment of a digital television receiver capable of removing co-channel NTSC interference from a digital television signal. FIG. 3 is a diagram of NTSC interference signal received by the digital television receiver.

As shown in FIG. 2A, television receiver 100A comprises a filtering system 10, a DC removal unit 20, a gain correction unit 30 and an equalization unit 40.

The filtering system 10 receives the digital signal S1 and outputs first signal S1″, in which the digital signal S1 comprises a digital television signal and a NTST co-channel interference signal. For example, the NTST co-channel interference signal received by the filtering system 10 can comprise a plurality of sections each comprising N symbols, as shown in FIG. 3. The NTST co-channel interference signal can comprise sections SEC₁˜SECₙ; each section SEC₁˜SECₙ comprising 684 symbols.

The filtering system 10 comprises a phase compensator 11, an averaging unit 13, a first synthesis filter 15, a second synthesis filter 17 and subtracting units 18 and 19. The phase compensator 11 is coupled between the received digital signal S1 and the multiplier 23 to compensate phase offset due to different NTSC-DTV station frequency offset. The phase compensator 11 is optional block and, for example, can be a phase tracker. In this embodiment, the phase compensator 11, according to different NTSC-DTV station frequency offset, generates a compensation signal SP to the multiplier 23 for phase offset compensation.

The averaging unit 13 generates an average signal by calculating an average over a received digital signal at periodic time instants (n−k*N). In this embodiment, N is a constant, n denotes the present time instant, and k is a non-negative integer. Namely, the averaging unit 13 generates an average signal SAD by averaging a plurality of symbols that have the same location in respective sections SEC₁˜SECₙ of the received digital signal S1. For example, the averaging unit 13 can generate an average signal SAD of the 676^{th} symbol in the section SEC₉ by averaging the 676^{th} symbols in the sections SEC₁˜SEC₈ as shown in FIG. 3.

As shown in FIG. 2A, the averaging unit 13 comprises a first attenuator 21, an adder 22, a multiplier 23, a first delay line 24, a second delay line 25, and a second attenuator 26. The first attenuator 21 has a first attenuation coefficient α and outputs a first attenuated signal SA1 according to the received digital signal S1. For example, attenuation coefficient α can be ½, ¼, ⅛ or less. The adder 22 is coupled to the first and second attenuators 21 and 26 to add a second attended signal SA2 to the first attenuated signal SA1 to generate an accumulated signal SAS.

The multiplier 23 is coupled between the adder 22 and the first delay line 24 to compensate the accumulated signal SAS according to the signal SP and output a compensated and accumulated signal SAS″. In this embodiment, the multiplier 23 is optional, and can be omitted when the phase compensator 11 is omitted.

The first delay line 24 delays the compensated and accumulated signal SAS″ by a first fixed number of symbols to output the average signal SAD. For example, the first fixed number can be 676, but is not limited thereto.

The second delay line 25 delays the average signal SAD by a second fixed number of symbols to output a delayed signal SD. For example, the second fixed number can be 8, but is not limited thereto. The second attenuator 26 has a second attenuation coefficient 1−α and outputs the second attenuated signal SA2 according to the delay signal SD. In this embodiment, the first fixed number (676) and second fixed number (8) equals 684, in each sections SEC₁˜SECₙ.

The first synthesis filter 15 filters the average signal SAD to generate a first estimated interference signal SEI1. The subtracting unit 18 subtracts the first estimated interference signal SEI1 from the received digital signal S1 and outputs a first signal S1″. The second synthesis filter 17 filters the first signal S1″ from the subtracting unit 18 to generate a second estimated interference signal SEI2. The subtracting unit 19 subtracts the second estimated interference signal SEI2 from the first signal S1″. In this embodiment, the first and second synthesis filters 15 and 17, can be comb filters, single-side finite impulse response (FIR) filters, symmetric-type FIR filters and the like. For example, the first synthesis filter 15 can be a 15-tap FIR filter with symmetric coefficients [3/32, 3/32, 3/32, 3/32, 0, −3/32, −3/32, −3/32, −3/32, 3/32, 3/32, 3/32, 3/32], and the second synthesis filter 17 can be a 12-tap FIR filter with symmetric coefficients [0, 5*3/64, 2*3/64, 1*3/64, 2*3/64, 4*3/64, 2*3/64, 1*3/64, 2*3/64, −5*3/64, 0, −5*3/64], in which the coefficients in the second synthesis initialize a decision feedback equalizer (DFE) in the equalization unit 40.

Namely, the filtering system 10 averages symbols having the same location in respective sections of the received digital signal to generate an average signal, and obtains an estimated interference signal according thereto and subtracts the estimated interference signal from the received digital signal.

### Second Embodiment

FIG. 2B shows a second embodiment of a digital television receiver capable of removing co-channel NTSC interference from a digital television signal.

As shown in FIG. 2B, television receiver 100A comprises a filtering system 10, a DC removal unit 20, a gain correction unit 30 and an equalization unit 40.

The filtering system 10 receives the digital signal S1 and outputs first signal S1″, the received digital signal S1 comprises a digital television signal and a co-channel NTSC interference signal. For example, the NTST co-channel interference signal received by the filtering system 10 can comprise a plurality of sections each comprising N symbols, as shown in FIG. 3. The NTST co-channel interference signal can comprise sections SEC₁˜SECₙ, and each section SEC₁˜SECₙ comprising 684 symbols.

The filtering system 10 comprises a phase compensator 11, an averaging unit 13, a first synthesis filter 15, a second synthesis filter 17 and subtracting units 18 and 19. The phase compensator 11 is coupled between the received digital signal S1 and the multiplier 23 to compensate phase offset due to different NTSC-DTV station frequency offset. The phase compensator 11 is an optional block and, for, example can be a phase tracker. In this embodiment, the phase compensator 11, according to different NTSC-DTV station frequency offset, generates a compensation signal SP to the multiplier 23 for phase offset compensation.

The second synthesis filter 17 filters the received digital signal S1 to generates a second estimated interference signal SEI2. The subtracting unit 19 subtracts the second estimated interference signal SEI2 from the received digital signal S1 and outputs a subtracted digital signal S2.

The averaging unit 13 generates an average signal SAD by averaging a plurality of symbols that have the same location in respective sections SEC₁˜SECₙ of the signal S2.

As shown, the averaging unit 13 comprises a first attenuator 21, an adder 22, a multiplier 23, a first delay line 24, a second delay line 25, and a second attenuator 26.

The first attenuator 21 has a first attenuation coefficient α and outputs a first attenuated signal SA1 according to the subtracted digital signal S2. The adder 22 is coupled to the first and second attenuators 21 and 26 to add a second attended signal SA2 to the first attenuated signal SA1 to generate an accumulated signal SAS. The multiplier 23 is coupled between the adder 22 and the first delay line 24 to compensate the accumulated signal SAS according to the signal SP and output a compensated and accumulated signal SAS″. In this embodiment, the multiplier 23 is optional, and can be omitted when the phase compensator 11 is omitted.

The first delay line 24 delays the compensated and accumulated signal SAS″ by a first fixed number of symbols to output the average signal SAD. The second delay line 25 delays the average signal SAD by a second fixed number of symbols to output a delayed signal SD. The second attenuator 26 has a second attenuation coefficient 1−α and outputs the second attenuated signal SA2 according to the delay signal SD. In this embodiment, the first fixed number (676) and second fixed number (8) equals N (684) in each section SEC₁˜SECₙ. The first synthesis filter 15 filters the average signal SAD to generate a first estimated interference signal SEI1. The subtracting unit 18 subtracts the first estimated interference signal SEI1 from the subtracted digital signal S2 and outputs a first signal S1″.

In this embodiment, the first and second synthesis filters 15 and 17 can be comb filters, single-side finite impulse response (FIR) filters, symmetric-type FIR filters and the like. For example, the first synthesis filter 15 can be a 15-tap FIR filter, and the second synthesis filter 17 can be a 12-tap FIR filter.

Namely, the filtering system 10 averages symbols having the same location in respective sections of the received signal to generate an average signal, and obtains an estimated interference signal according thereto and subtracts the estimated interference signal from the received digital signal.

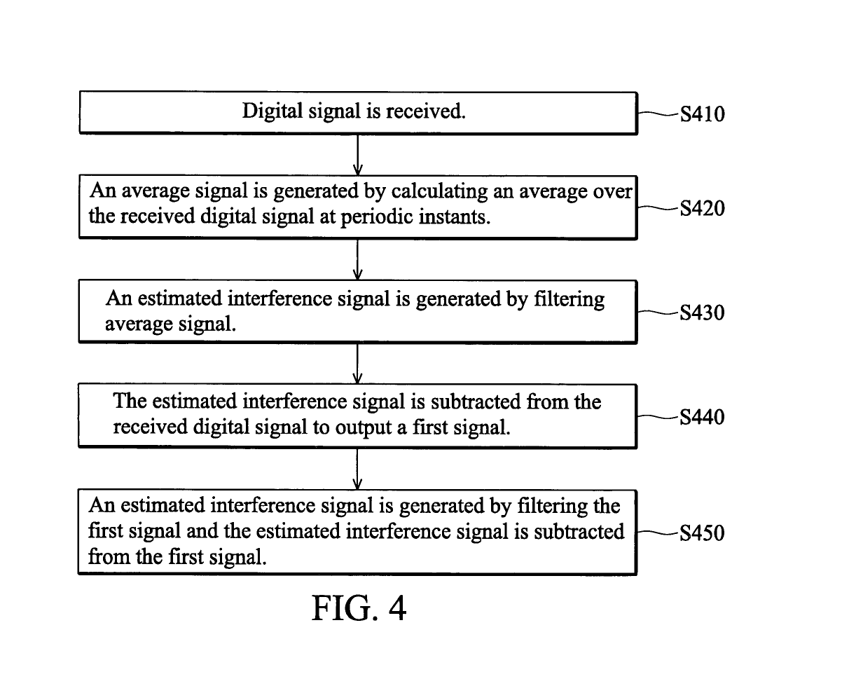

FIG. 4 is a flowchart showing an embodiment of a method for removing co-channel NTSC interference from a digital television signal in a digital television receiver. the digital signal is interfered by a co-channel NTSC interference signal, the NTSC interference signal consisting of a plurality of sections SEC₁˜SECₙ, each section SEC₁˜SECₙ comprises N symbols, such as 684 symbols as shown in FIG. 3.

In step S410, the digital signal S1 is received. For example, the received digital signal S1 can comprise a digital television signal and the co-channel NTSC interference signal.

In step S420, an average signal is generated by calculating an average over the received digital signal S1 at periodic time instants (n−k*N), wherein N is a constant, n denotes the present time instant and k is a non-negative integer. Namely, a plurality of symbols having the same location in respective sections of the received digital signal are averaged to generate an average signal SAD by averaging unit 13, with reference to FIG. 2A.

For example, a first attenuated signal SA1 can be generated, according to the received digital signal S1, by an attenuator 21 with a first attenuation coefficient α. The attenuation coefficient α can be ½, ¼, ⅛ or less. The first attenuated signal SA1 is then added to a second attended signal SA2 to generate an accumulated signal SAS by an adder 22. The accumulated signal SAS″ is delayed by a first fixed number of symbols to output the average signal SAD. The average signal SAD is delayed by a second fixed number of symbols to output a delayed signal SD, and the second attenuated signal SA2 is generated, according to the delay signal SD, by a second attenuator 26 with a second attenuation coefficient 1−α. For example, the first fixed number and the second fixed number are 676 and 8 respectively, but are not limited thereto, and the first fixed number (676) and second fixed number (8) equal N (684) in each sections SEC₁˜SECₙ.

In step S430, an estimated interference signal SEI1 is generated by filtering the average signal SAD by a first synthesis filter 15.

In step S440, the estimated interference signal SEI1 is subtracted from the received digital signal S1 and outputting a first signal S1″ by a subtracting unit 18.

In step S450, an estimated interference signal SEI2 is generated by filtering the first signal S1″ by a second synthesis filter 17 and the estimated interference signal SEI2 is subtracted from the first signal S1″ by a subtracting unit 19.

In some examples, step S450 can be executed between steps S410 and S420. With reference to FIG. 2B, a synthesis filter 17 filters the received digital signal S1 to generate an estimated interference signal SEI2, and a subtracting unit 19 subtracts the estimated interference signal SEI2 from the received digital signal S1 and outputs a subtracted digital signal S2 to the average signal SAD to the averaging unit 13. The averaging unit 13 then generates an average signal SAD by averaging a plurality of symbols having the same location in respective sections of the subtracted digital signal S2 in step S420. An estimated interference signal SEI1 is generated according to the average signal SAD by a first synthesis filter 15 in step S430, and the estimated interference signal SEI1 is subtracted from subtracted digital signal S2 and outputs a first signal S1″ by a subtracting unit 18 in step S440.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of removing co-channel interference from a digital signal, wherein the digital signal is interfered by an interference signal comprising consecutive sections, each of which contains N symbols, the method comprising:
receiving the digital signal;
generating an average signal by calculating an average over the received digital signal at periodic time instants (n−k*N), wherein N is a constant, n denotes the present time instant and k is a non-negative integer;
generating a first estimated interference signal by filtering the average signal; and
subtracting the first estimated interference signal from the received digital signal to output a first signal.

2. The method as claimed in claim 1, wherein the average signal at time instant n is generated according to the received digital signal at time instant n and the average signal at time instant n−N.

3. The method as claimed in claim 1, further comprising:
generating a second estimated interference signal by filtering the first signal; and
subtracting the second estimated interference signal from the first signal to output a second signal.

4. The method as claimed in claim 1, further comprising:
generating a second estimated interference signal by filtering the received digital signal; and
subtracting the second estimated interference signal from the received digital signal before generating the average signal.

5. The method as claimed in claim 1, wherein the received digital signal is a digital television signal and the interference signal is a NTSC signal.

6. A filtering system for removing co-channel interference from a digital signal, wherein the digital signal is interfered by an interference signal comprising consecutive sections, each of which contains N symbols, the filtering system comprising:
an averaging unit, generating an average signal by calculating an average over a received digital signal at periodic time instants (n−k*N), wherein N is a constant, n denotes the present time instant, and k is a non-negative integer;
a first synthesis filter, filtering the average signal to generate a first estimated interference signal; and
a subtracting unit, subtracting the first estimated interference signal from the digital signal to output a first signal.

7. The filtering system as claimed in claim 6, wherein the average signal at time instant n is generated according to the received digital signal at time instant n and the average signal at time instant n−N.

8. The filtering system as claimed in claim 6, wherein the averaging unit comprises:
a first attenuator with a first attenuation coefficient, outputting a first attenuated signal according to the received digital signal;
an adder adding a second attended signal to the first attenuated signal to generate an accumulated signal;
a first delay line delaying the accumulated signal by a first fixed number of symbols to output the average signal;
a second delay line delaying the average signal by a second fixed number of symbols to output a delayed signal; and
a second attenuator with a second attenuation coefficient, outputting the second attenuated signal according to the delayed signal,
wherein N equals the sum of the first fixed number and the second fixed number, and the sum of the first and second attenuation coefficients equals 1.

9. The filtering system as claimed in claim 8, further comprising a phase compensator coupled between the adder and the first delay line.

10. The filtering system as claimed in claim 7, further comprising:
a second synthesis filter filtering the first signal to generate a second estimated interference signal; and
a subtracting unit subtracting the second estimated interference signal from the first signal.

11. The filtering system as claimed in claim 7, further comprising:
a second synthesis filter filtering the digital signal to generate a second estimated interference signal; and
a subtracting unit subtracting the second estimated interference signal from the digital signal and outputting to the averaging unit to generate the average signal.

12. The filtering system as claimed in claim 7, wherein the digital signal is a digital television signal and the interference signal is a NTSC signal and.

13. A television receiver capable of removing co-channel interference from a digital signal, comprising:
a filtering system, receiving the digital signal and outputting a first signal, wherein the digital signal is interfered by an interference signal comprising consecutive sections, each of which contains N symbols, and the filtering system comprises:
an averaging unit, generating an average signal by calculating an average over a received digital signal at periodic time instants (n−k*N), wherein N is a constant, n denotes the present time instant and k is a non-negative integer;
a first synthesis filter, filtering the average signal to generate a first estimated interference signal; and
a subtracting unit, subtracting the first estimated interference signal from the received digital signal to output the first signal.

14. The television receiver as claimed in claim 13, wherein the average signal at time instant n is generated according to the received digital signal at time instant n and the average signal at time instant n−N.

15. The television receiver as claimed in claim 13, wherein the averaging unit comprises:
a first attenuator with a first attenuation coefficient, outputting a first attenuated signal according to the received digital signal;
an adder adding a second attended signal to the first attenuated signal to generate an accumulated signal;
a first delay line delaying the accumulated signal by a first fixed number of symbols to output the average signal;
a second delay delaying the average signal by a second fixed number of symbols to output a delayed signal; and
a second attenuator with a second attenuation coefficient, outputting the second attenuated signal according to the delayed signal,
wherein N equals the sum of the first fixed number and the second fixed number, and the sum of the first and second attenuation coefficients equals one.

16. The television receiver as claimed in claim 15, wherein the filtering system further comprises a phase compensator coupled between the adder and the first delay line.

17. The television receiver as claimed in claim 15, wherein the filtering system further comprises:
a second synthesis filter filtering the first signal to generate a second estimated interference signal; and
a subtracting unit subtracting the second estimated interference signal from the first signal.

18. The television receiver as claimed in claim 15, wherein the filtering system further comprises:
a second synthesis filter filtering the digital signal to generate a second estimated interference signal; and
a subtracting unit subtracting the second estimated interference signal from the digital signal and outputting to the averaging unit to generate the average signal.

19. The television receiver as claimed in claim 15, wherein the digital signal is a digital television signal and the interference signal is a NTSC signal.
